(19) United States
(12) Patent Application Publication
(10) Pub. No.: US 2010/0058820 A1
(43) Pub. Date: Mar. 11, 2010

(54) TIMER DEVICE FOR A CONTAINER

(76) Inventors: Tino Gurb, Kungsangen (SE); Peter Tornqvist, Lidingo (SE)

Correspondence Address: YOUNG & THOMPSON, 209 Madison Street, Suite 500, Alexandria, VA, 22314, US

(21) Appl. No.: 12/523,901

(22) PCT Filed: Jan. 25, 2008
(86) PCT No.: PCT/SE08/00064

§ 371 Date: Jul. 21, 2009

(30) Foreign Application Priority Data
Feb. 2, 2007 (SE) 0700261-1

(51) Int. Cl. E05B 43/00

(52) U.S. Cl. 70/267

(57) ABSTRACT

A timer device for a container with a handle mounted on a rotable axis, a locking device and a bar element. The locking device has a recess for receiving the handle, adapted to rotate between a locking position and an opening. The locking device in its locked position holds the bar element, while it in its opening position leaves the bar element moveable. In the locking position the bar element holds an opening of the container closed, while in the opening position tends to open the opening of the container. The device may be used for automatically opening a container, which may contain fodder for feeding horses, at a chosen time. Such a timer device for a container which has at least a first locking element and a second locking element is described

The present invention relates to a timer device for a container according to the introductory portions of the independent claim.

### BACKGROUND OF THE INVENTION

Devices for feeding animals at chosen times are previously known. Such devices generally have a complicated design, require a large space, are costly, require electrical power and are thus potentially hazardous to the animals.

An object of the invention is therefore to provide timer device for a container which does not require electrical power.

Other objects of the invention are to provide timer device for a container which is comparatively simple in its design and requires less space than previous solutions. The timer device for a container may be used for feeding horses, cattle, sheep, goats, lambs, game or fish.

These and other objects are attained by timer device for a container according to the characterising portion of the independent claim.

### SUMMARY OF THE INVENTION

The invention relates to a timer device for a container comprising a handle (8) mounted on a rotable axis, a locking device (3, 4, 12) and a bar element. The locking device has a recess for receiving the handle, and that the handle is adapted to rotate between a locking position where the locking device is held in place and an opening position where the locking device is moveable. The locking device in its locked position holds the bar element, while the locking device in its opening position leaves the bar element moveable. In the locking position the bar element holds an opening of the container closed, while the bar element in the opening position tends to open the opening of the container. The invention may be used for a automatically opening a container, which may contain fodder for feeding horses, at a chosen time. The container has a timing device advantageously does not need electric current and is comparatively simple in its design.

The invention further relates to such a timer device for a container which has at least a first locking element (3, 4, 12) and a second locking element (12). The first locking element cooperates with the handle and the second locking element, and the second locking element cooperates with the first locking element and the bar element. This has the advantage that the forces acting on the timer handle is minimized as two lever actions are achieved through the two locking elements.

### BRIEF DESCRIPTION OF THE DRAWINGS

FIG. 1 shows a perspective view with the fodder container in an open position.

FIG. 2 A detail of FIG. 1 shows a perspective view with the device for the fodder container in a closed position and where the timer 7 is set to requested time and thus the timer handle 8 turned clockwise prevents the front piece 4 from swinging out until the handle 8 is positioned in front of the front piece 4 recess 6 and allows the front piece 4 to swing out and open.

FIG. 3 A detail of FIG. 1 shows a perspective view with the device for the fodder container locked by the timer handle 8 turned maximally anti clockwise and prevents the front piece 4 from swinging out.

FIG. 4 shows a cross section with the device fodder container in a closed position, where the timer 7 is set to desired time and thereby the timer handle turned clockwise prevents the front piece 4 from swinging out until the handle 8 is in front of the front piece 4 recess 6 and allows the front piece 4 to swing out and open.

FIG. 5 shows a cross section with the device fodder container in an opened extended position. The handle 8 sits in front of the front piece 4 recess 6 and has thus allowed the front piece to swing out and open.

FIG. 6 shows a perspective view with the device arranged against a raisable boom 17 in a locked position, in this case locked by the timer handle 8 turned maximally counter clockwise and preventing the front piece 4 from swinging out.

FIG. 7 shows a cross section with the boom 17 in a locked position and where the timer 7 is set to desired time and thereby the timer handle 8 turned clockwise prevents the front piece 4 from swinging out until the handle 8 sits in front of the front piece 4 recess 6 and allows the boom 17 to rise from its locked position.

FIG. 8 shows a cross section with the device for the boom 17 in an opened extended position. The handle 8 sits in front of the front piece 4 recess 6 and has thus been allowed to swing out and allows the boom 17 to extend from its locked position.

### DESCRIPTION OF PREFERRED EMBODIMENTS

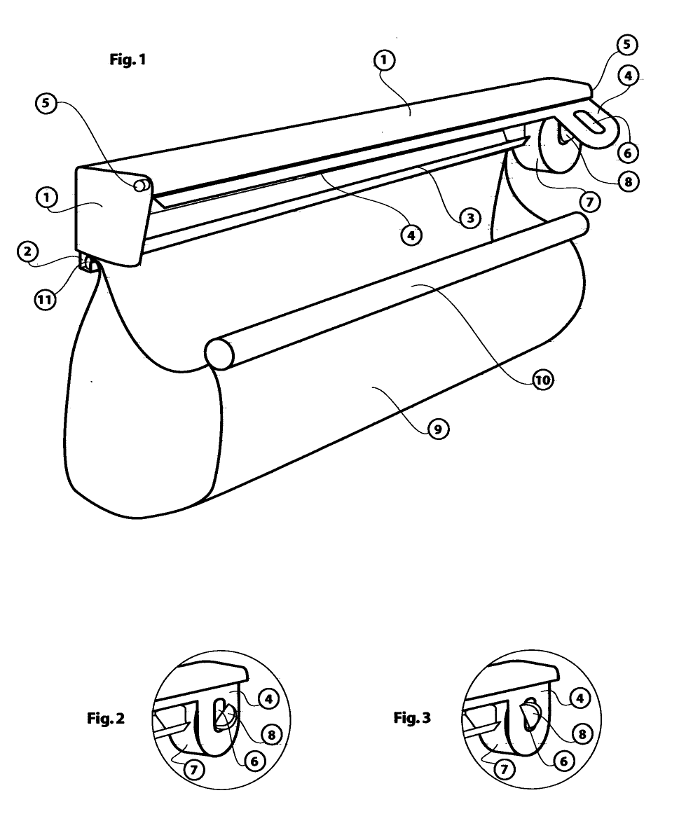

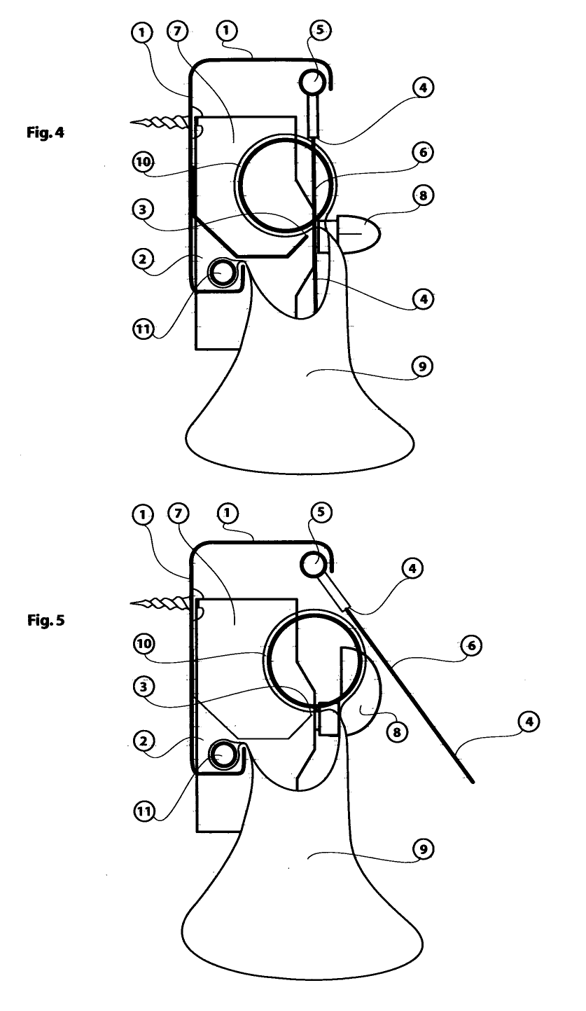

The device for feeding with a fodder container FIGS. 1, 2, 3, 4 and 5 comprises a rear piece 1 on which a timer 7 with a handle 8 has been attached. The rear piece 1 constitutes the framework of the device and is intended to be attached with screws or similar to i.a. a wall, a pole, a fence, a door etc.

The front piece 4 is turnable around the hinges 5. The front piece 4 has a recess 6 that fits against the handle 8, the action of which prevents or allows the front piece 4 to be turned relative to the rear piece 1 depending on the position of the handle 8.

The rear piece 1 is provided with a track 2 into which the rear keder 11 of a fodder container 9 is inserted. A horizontally turnable front piece 4 is situated on the upper part of the rear piece 1. Between the rear piece 1 and the front piece 4 there is space for the horizontally thickened long side 10 of the fodder container 9. The device is designed such that the horizontally thickened long side 10 of the fodder container 9 may be inserted in front of the rear piece 1 and behind the front piece 4. When the front piece 4 is turned, the thickened long side 10 is prevented from leaving this space. The accumulated weight of the fodder container 9 causes the force that acts on the leaving thickened long side 10. This force is minimized by two cooperating multiplying lever gears, one at the rear piece threshold 3 and the second at the lower leading edge of the front piece 4, thus the timer 7 or the handle 8 can be damaged.

After set time the handle 8 rotates back to its starting position, where the recess 6 on the front piece 4 ends up in front of the handle 8 and sets off the front piece 4, whereby the thickened long side 10 of the fodder container is allowed to slide over the threshold 3 and leave the device such that the fodder bag contents become available.

The timer 7 with the handle 8 may, if the handle is turned maximally clockwise, be set out of order if that is needed.

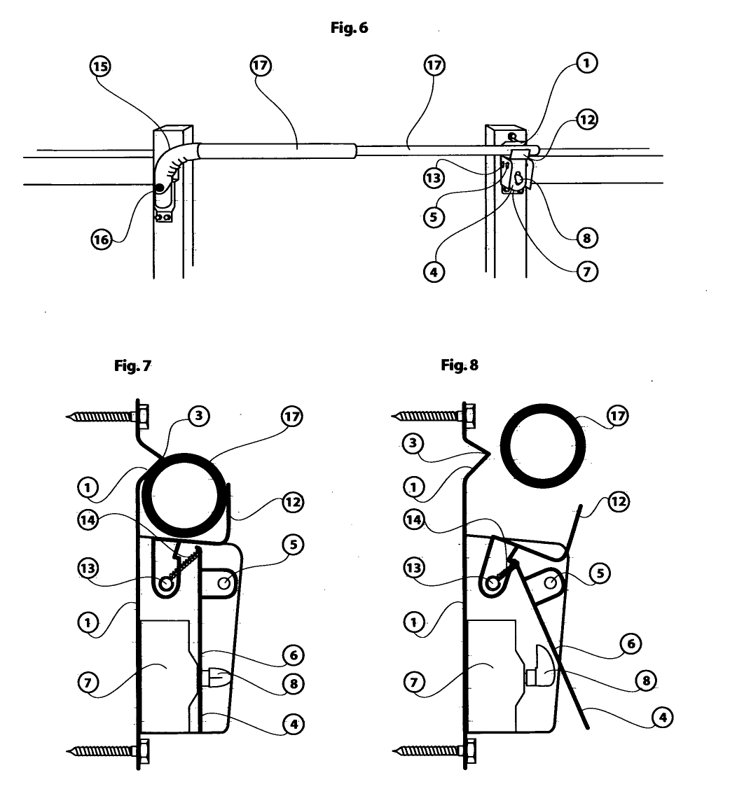

The device set for a riseable boom 17 FIGS. 6, 7 and 8 comprises everything mentioned above for feeding with a fodder container 9, but with the purpose of giving access to a separate area, and with the alteration that a further lever arm 12 with hinges 13 is added to completely remove the forces acting on the timer 7 and the handle 8. Instead of the two lever gears 3 and the front edge of the front piece 4, the two lever gears have been replaced by the lever 12 and its hinges 13. The reason for this is that the forces from the boom 17 can be so tremendously larger on the setting with the boom 17 than with the force from the thickened front rim 10 of the fodder container 9. The device consists, in addition to previously enumerated parts, of a boom 17, a covered tightly wound settable spring 15 which tends to force the boom to a vertical position. The settable spring 15 has a locking screw 16 which locks the boom 17 at desired lifting force. A spring 14 which loads the front piece 4 to be able to swing the front piece 4 up.

The devices work in all planes of direction for varying applications.

Specifically the invention relates to a device for opening containers or opening delimited areas at timed interval. The invention has a rear piece 1 which cooperates with a moveable part 4 (via a threshold edge 3) and lever gears during a specific time closing a thickened front edge 10 of a fodder container via its threshold edge 3 prevent its moveable part the thickened front edge 10 of the fodder container or boom to be moved. To when a certain time has passed the timer 7 and the handle 8 passes an opening 6 on the front piece 4 and allows the front piece 4 to turn away and the thickened front rim 10 of the fodder container via its threshold 3 to via gravity leave the rear piece 1 and the front piece 4 or the boom 17 by spring action.

The device can be set fully out of order if needed, by turning the handle 8 of the timer 7 maximally counter clockwise, whereby the front piece 4 is prevented from swinging out and the device is locked until it is reactivated.

The threshold 3 may cooperate with the thickened long side 10 and (the lower part of) the front piece 4 (creating a lever gear action). The device may have a track 2 for the keder 11 integral with the rear piece 1. Further, the front piece 4 may form a lever gear relative to the timer handle 8 (to give a small hanging out force affect timer 7 and timer handle 8). The timer 7 may be constituted by a settable mechanical clockwork, a settable electromagnetic latch. The settable electromagnetic latch may be constituted by a electromagnet which acts with polarity changing electromagnetic time circuit by the opening operation.

The fodder container 9 may be constituted by flexible substance, rigid plates or container. The device may have a settable 16 tightly wound spring 15. It may further have a lever 12 with hinges 13 and spring 14 that cooperates with the front piece 4. (To release the boom 17 and for complete force relief against the timer 7 and the handle 8).

1. A timer device for a container comprising a handle (8) mounted on a rotable axis, a locking device (3, 4, 12) and a bar element, where the locking device has a recess for receiving the handle, such that the handle is adapted to rotate between a locking position where the locking device is held in place and an opening position where the locking device is moveable, characterised in that said locking device in its locked position holds the bar element, while said locking device in its opening position leaves the bar element moveable, and in that said bar element in the locking position holds an opening of said container closed, while said bar element in the opening position tends to open the opening of the container.

2. A timer device for a container according to claim 1, characterised in that said locking device comprises at least a first locking element (3, 4) and a second locking element (3, 12), where the first locking element cooperates with the handle and the second locking element, and where the second locking element cooperates with the first locking element and the bar element.
